(19) United States
(12) Patent Application Publication
(10) Pub. No.: US 2005/0150679 A1
(43) Pub. Date: Jul. 14, 2005

(54) Abrasion-resistant jacket

(75) Inventors: Ferdinand Grogl, Nurnberg (DE); Alfred Mehl, Georgensgmund (DE)

Correspondence Address: SUGHRUE MION, PLLC, 2100 PENNSYLVANIA AVENUE, N.W., SUITE 800, WASHINGTON, DC, 20037, US

(73) Assignee: NEXANS

(21) Appl. No.: 10/800,674

(22) Filed: Mar. 16, 2004

(30) Foreign Application Priority Data
Mar. 17, 2003 (EP) 03290667.9

(51) Int. Cl. H01B 7/00

(52) U.S. Cl. 174/120 R

(57) ABSTRACT

An abrasion-resistant jacket for a flexible cable with a cable core and a jacket made of an abrasion-resistant thermoplastic material surrounding the cable core, particularly for a drag chain cable or a robot cable. The jacket includes an inner extruded plastic layer (2) and an outer jacket layer (4). Between the inner plastic layer (2) and the outer jacket layer (4) is a layer (3) of monofilaments made of a chemically and thermally stable material with a visual coverage of 40 to 70%. The outer jacket layer (4) is applied by pressure extrusion, such that the spaces in the layer (3) are almost filled by the material of the outer jacket layer, and the layer (3) adheres to the inner sheath layer (2).

This application is based on and claims the benefit of European Patent Application No. 03290667.9 filed Mar. 17, 2003, which is incorporated by reference herein.

### BACKGROUND OF THE INVENTION

The invention relates to an abrasion-resistant jacket for a flexible cable with a cable core and a jacket made of an abrasion-resistant thermoplastic material surrounding the cable core, particularly for a drag chain cable or a robot cable.

To control modern robotic and handling systems, lines with a high degree of flexibility and fatigue strength under reversed bending stress are required. Such lines are in continuous motion during operation. They must withstand torsion values of ±440° in continuous operation.

The October 2000 issue, volume 82 of the periodical “Elektrotechnik” describes a highly flexible cable for use in modem robots in which several individual cables are accommodated in a hybrid line. The individual cables are unit stranded around a conductive core. To minimize friction of the individual structural elements, these elements have low-friction insulating surfaces and extensive wrapping. Preferred insulation materials are those based on polyurethane, which are distinguished by high abrasion resistance and resistance to hydraulic fluid and mineral oil. Thermoplastic elastomers are used for the jacket, so that the jacket is resistant to notching and abrasion.

In addition to this material, a halogen-free and self-extinguishing polyurethane-based jacket material has become known in the art, which is being used with great success for welding lines because of its high flexibility and extreme protection against weld spatters.

As a result of the significant mechanical loads due to bending, torsion and especially friction which occurs frequently because of tight spaces, abrasion of the jacket is so severe that the cables have to be replaced after a short time. Downtimes are expensive, however, and the operators of assembly lines equipped with robots are very reluctant to accept them.

### SUMMARY OF THE INVENTION

Thus, the object of the present invention is to improve the abrasion resistance of the outer jacket, without increasing the jacket weight, and thereby increase the useful life of such cables.

This object is attained by an abrasion resistant jacket wherein the jacket is made of an inner extruded plastic layer (2) and an outer jacket layer (4), between the inner plastic layer (2) and the outer jacket layer (4) a layer (3) made of monofilaments of a chemically and thermally stable material is provided with a visual coverage of 40 to 70%, and the outer jacket layer (4) is applied by pressure extrusion, such that the spaces in the layer (3) are nearly filled by the material of the outer jacket layer, and the layer (3) adheres to the inner sheath layer (2).

The essential advantage of the invention is that jacket abrasion, as it occurs in cable jackets of the prior art, is either stopped or at least strongly reduced by the additional layer. The oil or media resistance of the entire line or the entire cable is improved because the monofilaments used are highly resistant against oils and other media. The flame resistance of the line or the jacket can be improved by the use of filament materials that have been made flame resistant. A further essential advantage is that the solution according to the invention makes it possible to reduce the wall thickness. This is advantageous with respect to the outside diameter and the flexibility of the cable or line. By improving the mechanical properties of the line or cable, it is possible under some circumstances to dispense with the costly grease that operators often use.

### BRIEF DESCRIPTION OF THE DRAWINGS

The invention will now be described in greater detail, by way of example, with reference the drawings, wherein:

FIG. 1 schematically illustrates an abrasion resistant jacket according to the invention; and

FIG. 2 schematically illustrates and alternative embodiment of the invention.

### DETAILED DESCRIPTION OF THE INVENTION

In the figures, 1 designates the cable core, which can include a plurality of electric wires with different cross sections. The cable core can also include one or more—electrical or optical—data lines.

The cable core 1 is surrounded by a plastic layer 2, which can be an inner sheath or a plastic layer enclosing the cable core 1.

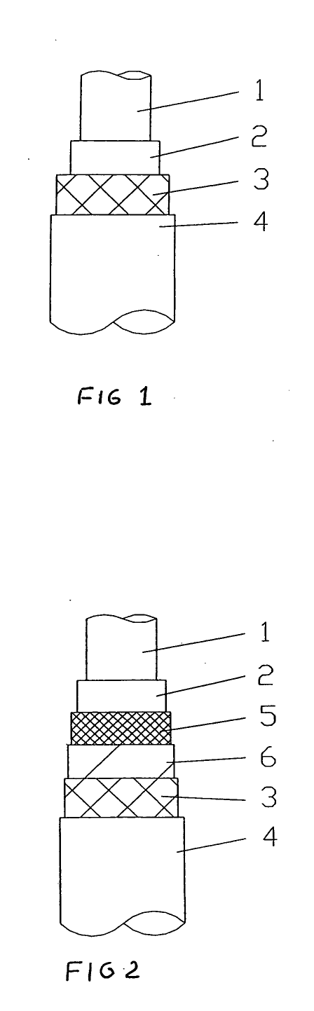

In the embodiment shown in FIG. 1, a braid 3 made of monofilaments is applied to the plastic layer 2. The braid 3 has a visual coverage of between 40 and 70%. The individual monofilaments are preferably made of polyethersulfone or polyamide. As an alternative to these materials, monofilaments made of polyterephthalate, polyurea, polycarbonate, polyacrylonitrile, polyvinylchloride, polyethylene and polypropylene may be used. The materials are preferably made flame resistant.

The monofilaments preferably have a diameter of 0.15 to 0.25 mm.

Instead of braiding, it is also possible to use stranding of the monofilaments. This solution is particularly advantageous in lines subject to strong torsional loading.

A plastic jacket 4 is applied to the layer 3 by means of pressure extrusion, i.e., the plastic material of the jacket 4 is pressed into the free spaces of layer 3, such that a bond results between the layers 2, 3 and 4. The jacket 4 is preferably made of polyurethane or a thermoplastic elastomer (TPE-O), e.g., Santoprene.

In the embodiment of the invention shown in FIG. 2, a metal braid 5 is further provided between the inner layer 2 and the layer 3. This metal braid acts as an electric shield for the line or the cable. A copper braid shield is preferred.

Between the shielding braid 5 and the layer 3, a plastic foil 6, e.g., made of polyurethane or polyethylene terephthalate is provided.

1. An abrasion-resistant jacket for a flexible cable with a cable core and a jacket made of an abrasion-resistant thermoplastic material surrounding the cable core, particularly for a drag chain cable or a robot cable, wherein the jacket is made of an inner extruded plastic layer (2) and an outer jacket layer (4), between the inner plastic layer (2) and the outer jacket layer (4) a layer (3) made of monofilaments of a chemically and thermally stable material is provided with a visual coverage of 40 to 70%, and the outer jacket layer (4) is applied by pressure extrusion, such that the spaces in the layer (3) are nearly filled by the material of the outer jacket layer, and the layer (3) adheres to the inner sheath layer (2).

2. An abrasion-resistant jacket as claimed in claim 1, wherein the layer (3) comprises a braid of monofilaments.

3. An abrasion-resistant jacket as claimed in claim 1, wherein the layer (3) comprises at least one layer of monofilaments stranded over the cable core (1).

4. An abrasion-resistant jacket as claimed in claim 1, wherein the layer (3) comprises monofilaments made of polyamide, preferably polyamide 6.

5. An abrasion-resistant jacket as claimed in claim 1, wherein the layer (3) comprises monofilaments made of polyethersulfone.

6. An abrasion-resistant jacket as claimed in claim 1, for a cable with a metal braided shield, further comprising a separation layer of a non-woven material or a plastic foil (6) between the braided shield (5) and the layer (3).

7. An abrasion-resistant jacket as claimed in claim 6, wherein the non-woven material or the plastic foil (6) is coated with a powder that swells in the presence of moisture.

8. An abrasion-resistant jacket as claimed in claim 1, for a cable with a plurality of wires, wherein the wires are embedded in an inner sheath.

9. An abrasion-resistant jacket as claimed claim 1, wherein the visual coverage of the layer (3) is between 50 and 65%.

10. An abrasion-resistant jacket as claimed in claim 1, wherein the diameter of the monofilaments is between 0.15 and 0.25 mm.

11. An abrasion-resistant jacket as claimed in claim 1, wherein the jacket is made of polyurethane, polyvinylchloride or a thermoplastic elastomer.

12. An abrasion-resistant jacket as claimed in claim 1, wherein the monofilaments contain a fireproofing agent.
